(19) United States
(12) Patent Application Publication
(10) Pub. No.: US 2013/0074974 A1
(43) Pub. Date: Mar. 28, 2013

(54) DUCTWORK STIFFENER

(71) Applicant: Phillip W. Murchie, Oak Grove, MO (US)

(72) Inventor: Phillip W. Murchie, Oak Grove, MO (US)

(21) Appl. No.: 13/245,404

(22) Filed: Sep. 26, 2011

(51) Int. Cl. F16L 9/04

(52) U.S. Cl. 138/172

(57) ABSTRACT

The ductwork utilized in heating and air conditioning systems is provided with internal crossbars secured to the sides of the duct to prevent inward or outward flexing in response to a pressure differential that could otherwise cause collapse of the sides, either inward or outward, and failure of system. The crossbars are spaced along the run of the duct with the opposed ends of each crossbar received within and secured to corresponding sockets mounted internally on opposite walls of the duct.

### FIELD OF THE INVENTION

This invention relates to ductwork utilized in heating and air conditioning systems to convey forced air from a heating or an air conditioning system to outlets that supply heated, ambient or refrigerated air to a home, building or other enclosed structure and, more particularly, to an improvement in such systems which minimizes the likelihood of distortion of the walls of the ductwork in response to a pressure differential, i.e., outward distortion and collapse of the walls in response to an increase in internal pressure, or inward distortion of the walls in response to a decrease in internal pressure.

### BACKGROUND OF THE INVENTION

Forced air heating and air conditioning systems employ runs of ductwork from the heating/cooling source to the rooms or other interior spaces of a home, commercial building or other structure. Heated or chilled air is supplied via conduits to various rooms of a home, occupied spaces of commercial buildings, schools and hospitals, and other structures that may be occupied by people or utilized for industrial or storage purposes. Typically, runs of ductwork extend from the heat source to the various outlet ducts and are temperature controlled by a thermostat. Failure of these systems may occur from time to time, however, and a common cause of such failure in large installations in particular is a collapse of the ductwork that carries the heat or air conditioning load. In particular, excess internal or external pressure is a common cause of the damage to ductwork resulting in distortion or collapse of the walls of the ductwork in response to the pressure imbalance. In addition to excess pressure, inadequate support of the ductwork may also cause distortion or collapse of the ducts and undesired sound due to pressure differential that may annoy occupants of the building.

### SUMMARY OF THE INVENTION

In an embodiment of the present invention the aforementioned problem is addressed by providing, in one aspect of the present invention, a crossbar in the duct having a pair of opposed ends received by receptacles secured to opposite sides of the duct to prevent flexing of the sides of the duct and ultimate failure in response to a pressure differential.

In another aspect of the invention, pairs of inwardly projecting, opposed receptacles are secured to opposite sides of the duct and each have a recess therein receiving a corresponding end of a crossbar to thereby prevent flexing of the sides of the duct and failure thereof in response to a pressure differential.

In another aspect of the invention, the crossbars are employed in pairs spaced along the length of the duct with the crossbars of each pair disposed at approximately a right angle to each other, thus providing additional resistance to flexing of the sides of the duct in response to a pressure differential.

A further aspect of the present invention is the utilization of opposed sockets within the ductwork that project thereinto and receive the corresponding ends of the installed crossbar, wherein the ends in the sockets are held against withdrawal by a cross-screw engaging the socket and the crossbar to secure the received end of the crossbar to the socket.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 is a perspective view of a short stretch of a heating and air conditioning duct showing the addition thereto of the internal components of the present invention.

FIG. 2 is a top plan view of the duct of FIG. 1 showing two crossbars spanning opposed sides of the rectangular duct and fastened at their ends to the respective walls utilizing inwardly projecting, opposed receptacles of the present invention.

FIG. 3 is a plan view of one of the sockets that receives and holds the end of a crossbar.

FIG. 4 is a side view of one of the sockets on the same scale as FIG. 3 showing attachment of the socket to the duct, and a cross-screw that secures the socket to an end of a crossbar (shown in broken lines).

FIG. 5 is a partial section of the socket at a right angle from the view of FIG. 4.

FIG. 6 is a perspective view showing one end of a installed crossbar and socket.

### DETAILED DESCRIPTION

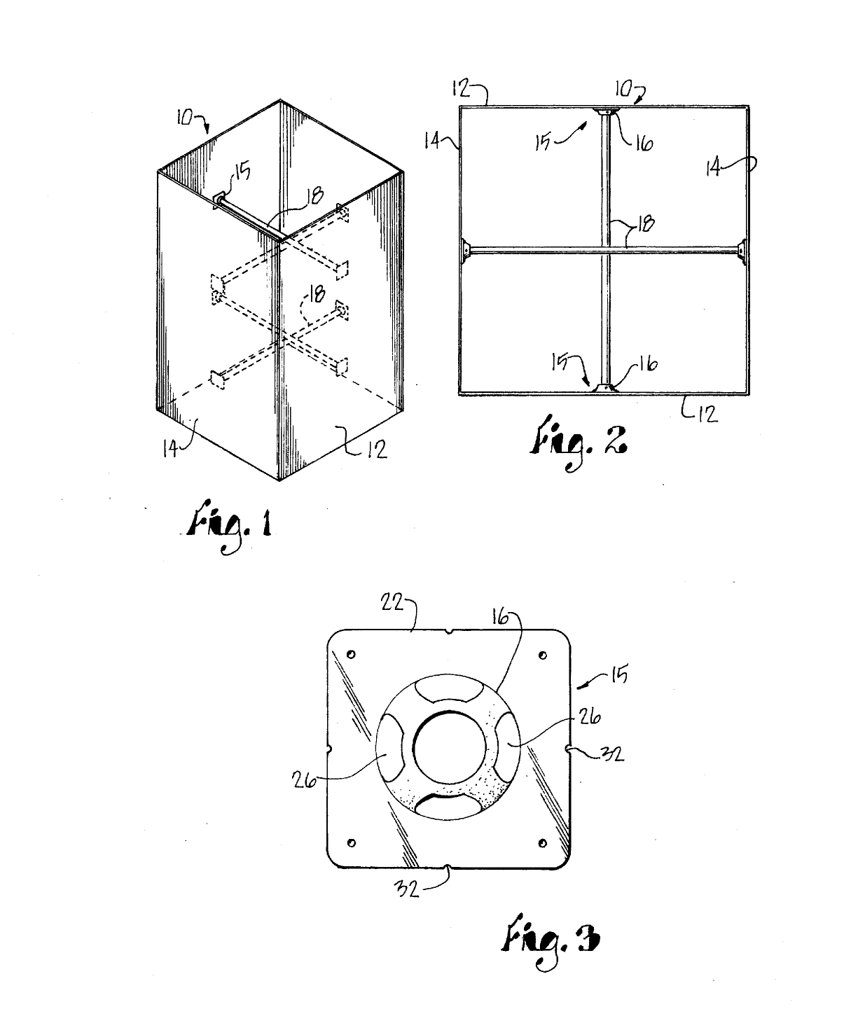

Referring initially to FIGS. 1 and 2, a relatively short segment of ductwork 10 is shown for illustrative purposes, it being appreciated that in an actual installation in a home, building or other structure, the duct will extend a considerable length to provide heating and air conditioning to the various rooms or areas of the home or building. The particular duct 10 illustrated is square in cross section but may be of other geometric shapes as dictated by design. The diameter of crossbars is selected depending on the size of the duct and the pressure applied.

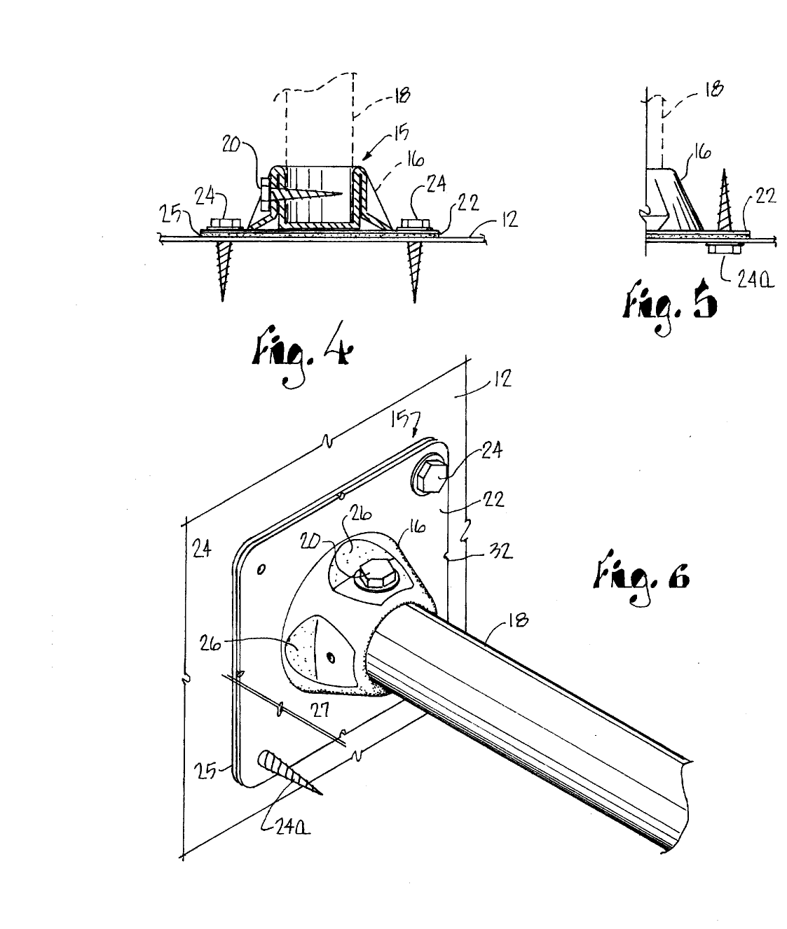

Opposed sides 12 and 14 of the duct 10 present a square cross-sectional configuration in the illustrated example. A first pair of inwardly projecting, opposed receptacles 15 present aligned sockets 16 that receive and secure the respective ends of a crossbar 18 as best shown in FIGS. 4 and 6 where one of the opposed ends of the crossbar 18 is shown inserted into socket 16 and held by cross screw 20. Successive pairs of opposed sockets 16 secure pairs of crossbars 18 to opposed walls of the duct 10 as illustrated in FIG. 1 where two spaced pairs of crossbars 18 are illustrated. Although each of the sockets 16 shown presents a circular opening for receiving the end of a crossbar, other opening configurations (square for example) would be employed as required to mate with the end of the supported crossbar. In a complete duct system the spaced pairs of crossbars 18 would be installed along the entire length of the ductwork from the heating/air conditioning source to the duct outlets.

FIGS. 4, 5 and 6 further show the manner of attachment of each of the crossbars 18 to the associated sockets 16. Each socket 16 projects from a mounting plate 22 (which may be square as illustrated) secured to the associated side or wall 12 or 14 of the duct 10 by two or more spaced sheet metal screws 24 or other suitable attachment means. Preferably, a precut neoprene pad 25 underlies each of the plates 22 to assure proper seating. Each screw 24 may be inserted from within the duct (FIG. 4) or, more typically, from outside the duct 10 as illustrated in FIGS. 5 and 6 which shows one screw 24a projecting into the duct. As illustrated, each of the sockets 16 has four recesses 26 presenting quadrants, each of which has a central opening 27 for receiving the cross-screw 20 that extends into the socket and into an opening 30 in the associated crossbar to fasten it to the socket. Typically, two screws 24 inserted at diagonally opposite corners of each plate 22 adequately secure each socket 16 to the wall of the air duct 10, but four screws 24 (not illustrated) may be used if desired. To assure proper alignment, a centering notch 32 (FIGS. 3 and 8) is provided in each edge of each plate 22.

It should be understood while certain forms of this invention have been illustrated and described, it is not limited thereto except insofar as such limitations are included in the following claims.

Having thus described the invention, what is claimed as new and desired to be secured by Letters Patent is as follows:

1. In an air duct having opposed sides, an improvement comprising:
a crossbar in the duct having a pair of opposed ends,
a pair of inwardly projecting, opposed receptacles secured to respective opposite sides of the duct and each having a recess therein receiving a corresponding end of said crossbar to prevent displacement thereof, and
a fastener on each of said receptacles securing the received end of the crossbar thereto to prevent withdrawal of the crossbar from the receptacles when the air duct is pressurized, whereby to preclude inward or outward flexing of said sides of the duct in response to a pressure differential.

2. The air duct as claimed in claim 1, wherein a plurality of said crossbars and receptacles are spaced along said duct.

3. The air duct as claimed in claim 2, wherein said plurality of said pairs of crossbars and receptacles are spaced along said length of the duct with the crossbars disposed at approximately a right angle to each other, whereby to provide additional resistance to flexing of the sides of the duct in response to a pressure differential.

4. The air duct as claimed in claim 1, whereby each of said receptacles has a socket projecting into said duct and presenting said recess receiving the corresponding end of the associated crossbar, and wherein said fastener thereof engages the received end of the crossbar and secures the received end to the socket.

5. The air duct as claimed in claim 4, wherein said fastener comprises a cross screw engaging said socket and said crossbar to secure said received end of the crossbar to the socket.
